(19) United States
(12) Patent Application Publication
(10) Pub. No.: US 2012/0278787 A1
(43) Pub. Date: Nov. 1, 2012

(54) COLLABORATIVE REALTIME PLANNING USING A MODEL DRIVEN ARCHITECTURE AND ITERATIVE PLANNING TOOLS

(75) Inventors: Vincent Wing Sang Chong, Union City, CA (US); Ashok Mukherjee, Irving, TX (US); Winson W. Quock, San Ramon, CA (US)

(73) Assignee: Modria, Inc.

(21) Appl. No.: 13/457,326

(22) Filed: Apr. 26, 2012

Related U.S. Application Data
(63) Continuation of application No. 12/425,335, filed on Apr. 16, 2009, now abandoned.
(60) Provisional application No. 61/045,604, filed on Apr. 16, 2008.

(51) Int. Cl. G06F 9/44; G06F 15/16

(52) U.S. Cl. 717/104

(57) ABSTRACT

Systems and methods are disclosed that include creating a template file with at least one logic unit. These systems and methods also include creating model file with at least one type independent information element. The type independent information has at least two values associated with it. In addition, there are systems and methods interpreting the data comprised within the model file using the template file. A program is created in some embodiments using data that has been created.

### CROSS REFERENCE TO RELATED APPLICATIONS

The present application is a continuation of prior U.S. patent application Ser. No. 12/425,335, filed on Apr. 16, 2009 which claims priority under 35 U.S.C. 119(e) to U.S. Provisional Patent No. 61/045,604, filed Apr. 16, 2008, entitled “A Method for Collaborative Planning Utilizing Real-Time What-If Analysis”.

### TECHNICAL FIELD

Generally, the invention relates to computer networks, and, more particularly, the invention Relates to dynamic collaborative planning and analysis.

### BACKGROUND

Current supply chain planning approaches are typically based on batch-run software application systems. These types of systems have significant limitations when it comes to supporting the users in making the best planning decision in supply chain functions such as production planning, inventory planning, distribution planning, and replenishment planning, when planners are faced with conflicts between the plan output provided by the optimization algorithms of the batch-run system, and their business reality. When conflicts occur, planners and their managers like to use ‘what-if’ analysis to explore multiple options for resolving the conflicts and select the one they decide is the best. A key limitation of current planning systems is the inadequacy of their ‘what-if’ analysis in resolving planning conflicts. Human knowledge of real business situations and human intelligence about decision-making cannot be applied at the planning stage. As a result, businesses find themselves trying to do the best they can by tweaking an infeasible plan, rather than Starting with a feasible and good plan in the first place.

An example of the above is the desire of manufacturers to maximize capacity utilization and minimize material inventories. Conventional planning practice as supported by existing software in the marketplace typically attempts to solve this as an optimization problem where both constraints are solved simultaneously by computer algorithms. When the resulting plan shows conflicts, the planner would ideally like to selectively change parameters such as delivery date and time, material arrival time and quantity, or capacity allocation and conduct what-if analysis to resolve the conflicts. Further, the planner would like to do such analysis with the most current data to ensure that the plan is consistent with the business reality at the time of publication of the plan. However, today's systems do not provide such ability, and thus, the planner cannot effectively make changes to the plan using his or her business knowledge of the reality.

Given the limitations of the current approaches, there is a need for a new approach that allows effective what-if analysis to enable planners and managers to create a feasible or executable plan. The approach should let each business do ‘what-if’ analysis consistent with the realities of that business. Further, for many companies, there is an associated need for ‘what-if’ analysis to be successful to enable planners in different parts of a global corporation to do the analysis collaboratively.

### SUMMARY OF INVENTION

In one embodiment, a method is disclosed that includes creating a template file with at least one logic unit. This method also include creating model file with at least one type-independent information element. The type independent information has at least two values associated with it. In addition, this method of interpreting the data comprised the model file using the template file. A report is created in some embodiments using the data that has been created.

In another embodiment, a system is disclosed that includes a memory configured to store at least one template file and at least one model file and a processor configured to execute the instructions used to interpret the at least one template file and import at least some data from the at least one model file. The processor generates a report comprising data related to the one template file and one model file.

In yet another embodiment, a system is disclosed that includes a first computer comprising a CRP device with a model file, a template file, and a MDA code generator. The first computer comprises a network interface. This system may include a second computer comprising a second network interface. The second computer uses the second network interface to communicate with the first user interface and alters the model file.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram of one system of implementing the collaborative real-time planning (CRP) system according to one exemplary embodiment.

FIG. 2 is a block diagram of one implementation of the design operation according to one exemplary embodiment.

FIG. 3 is a block diagram of one implementation of the run operation according to one exemplary embodiment.

FIG. 4 is a block diagram of one integrated implementation of the CRP system according to one exemplary embodiment.

FIG. 5 is a block diagram of one implementation of the model files according to one exemplary embodiment.

FIG. 6 is a block diagram of one implementation of the template files according to one exemplary embodiment.

FIG. 7 is a block diagram of one implementation of the planning process according to one exemplary embodiment.

FIG. 8 is a block diagram of one implementation of the implementation of one interface according to one exemplary embodiment.

FIG. 9 is another block diagram of a second implementation of one interface according to one exemplary embodiment.

FIG. 10 is a flowchart of one method of setting up data classes according to one exemplary embodiment.

FIG. 11 is a flowchart of one method of revising data classes according to one exemplary embodiment.

FIG. 12 is a block diagram of one computer system capable of executing the plurality of embodiments disclosed herein.

FIG. 13 illustrates an example material and capacity planning process for production of goods and services according to one embodiment of the present disclosure.

### DETAILED DESCRIPTION

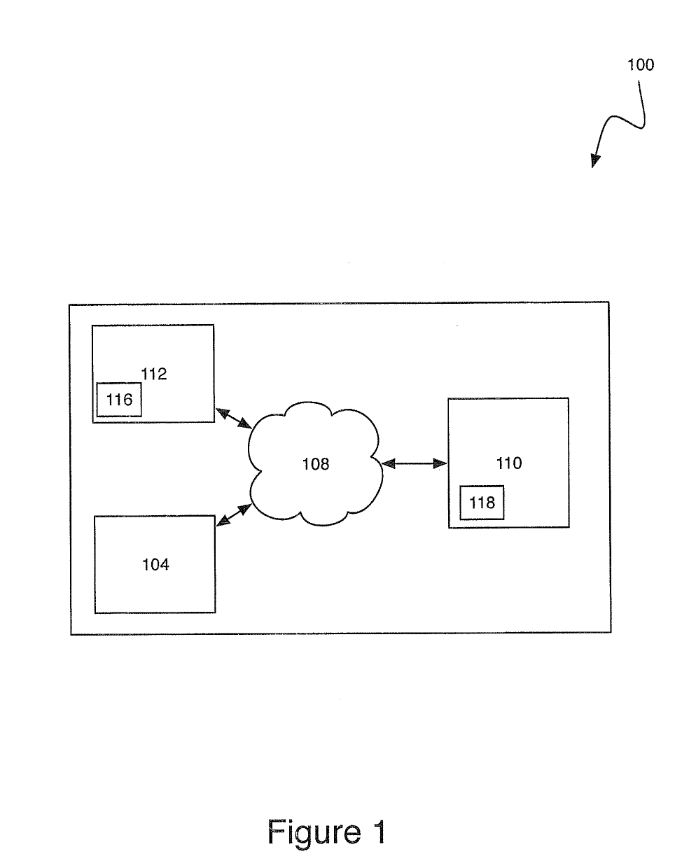

FIGS. 1 through 13, discussed below, and the various embodiments used to describe the principles of the present disclosure in this patent document are by way of illustration only and should not be construed in any way to limit the scope of the disclosure. Systems and methods disclosed herein are related to a collaborative real-time planning (CRP) system using a model driven architecture (MDA) capable of providing real-time analysis in developing optimal resource allocation and management planning. The CRP system allows for a robust reusable code base to be used across various platforms and addresses various types of problems irrespective of specific types of data. The CRP system may employ generative programming techniques that simultaneously generate various tiers of code that may be used in any type of application. These tiers may include, but are not limited to, a persistent layer (database), an application logic layer, and a presentation layer (user interface). These and other embodiments of the present disclosure will be discussed below.

Disclosed are systems and methods that relate to the use of a model driven architecture within collaborative planning. This approach allows for a user to use type independent data to perform data processing, and also allows for collaborative planning between pluralities of participants.

For instance, in a production-planning environment, the model driven architecture permits the usage of type independent data stored within a plurality of files combined with type independent code stored within a second plurality of files to generate the optimal program to determine the best resource allocation within the production-planning environment. These systems and methods may also be used to generate a user interface based upon the type independent data and the type independent code that allows a user to interact with the type independent data. The result of the model driven architecture is, in some embodiments, executable code that allows a user to interact with the type independent data and determine a preferred resource allocation within the production-planning environment.

The systems and methods of collaborative planning enable the creation of a plurality of outputs including reports that, in some embodiments, plan the resource allocation of goods and services in the production environment. Through an interactive process that takes into account a plurality of different elements, an iterative process can alter the inputs into the model driven application. These inputs can then be used to generate one or more outputs including reports that represent an optimal use of resources within the production-planning environment.

FIG. 1 is an example of a system 100 that uses the CRP system. FIG. 1 comprises a client 104, a client 112, and a client 110 in communication with each other through a large area network 108. Also shown in FIG. 1 is a CRP system 116 and a CRP system 118. In one embodiment of the disclosure, client 112 uses CRP 116 to generate an optimized management allocation plan (OMAP) based upon at least one model and one template file. This OMAP may be shared with clients 104 and 110. Clients 104 and 110 may have input regarding the parameters used to generate the OMAP, and subsequent to this, may revise the OMAP by using either CRP 116 or 118.

While not explicitly shown in FIG. 1, it is understood that any number of disclosed clients may communicate directly or individually with those disclosed. One of the innovative features disclosed is the ability to have collaboration from a plurality of sources.

Client 112, 104, and 110 may be any device known to one skilled in the art such as a mobile handset, a computer, personal data assistant (PDA), or any other device capable of altering parameters used by CRP 116 or 118. In some embodiments, client 112 is a network-based device capable of accepting input from at least one source.

Large area network 108 is a network with a plurality of nodes capable of connecting a plurality of devices. In one embodiment, large area network 108 may be the Internet. In another embodiment, large area network 108 may be an intranet.

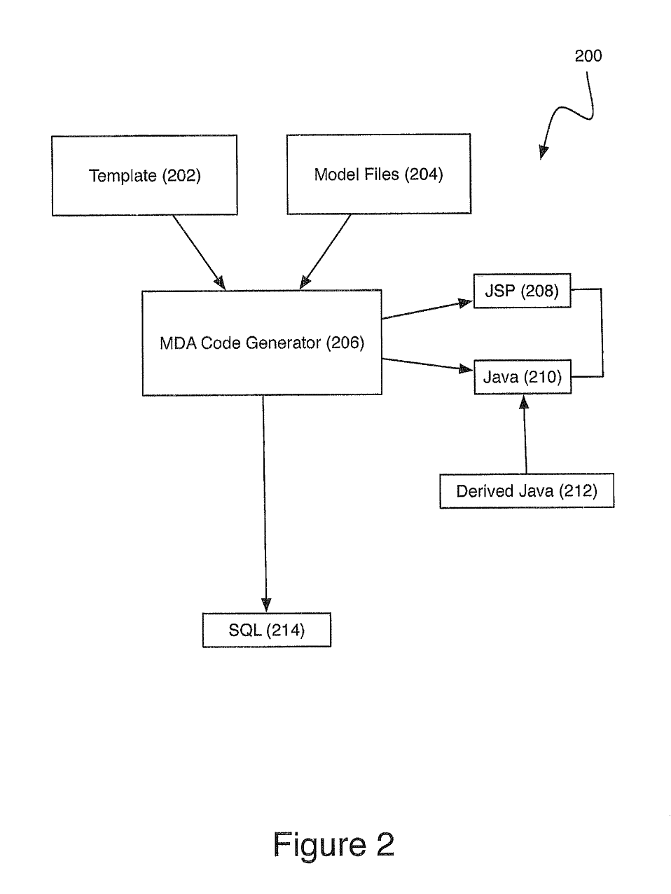

FIG. 2 is a block diagram of the design operation for the creation of an OMAP application. In the example illustrated by FIG. 2, at least one template file 202 and at least one model file 204 are input into an MDA code generator 206. The MDA code generator 206 creates JSP code 208, Java code 210, and SQL code 214. The created JAVA code 210 may further use derived JAVA 212 obtained from a third source (such as another generic code source, e.g., snippet files) as an input and the code created by the MDA code generator 206.

Template files 202 are a set of files, which may include instructions relating to the interpretation of data, found within the model files 204. This data may be stored in a JAVA accessible format allowing for the generation of output (data) as well as data used to interpret output data (e.g., user interface data). Examples of template files 202 may include code, which creates correlations between various types of other information (e.g., aggregates information found within the model files).

A model file 204 contains object definitions as well as other objects that are used in the creation of the objects. Examples of those objects will be discussed below.

One of the innovative elements of the structure illustrated by FIG. 2 is the ability to leverage componentized software such as JAVA and the J2EE architectural specification to optimize an OMAP using the MDA code generator 206. The MDA code generator 206 generates meta information to be used at run time to access the underlying classes' attributes. An example of a segment of pseudo JAVA code that may be used to create a new object is reproduced below:
Object anyObject=ObjectFactory.getInstance(“PurchaseOrder”);
anyObject.setField(“ID,”,‘PO001’);
anyObject.setField(“quantity”, 100);

This coding pattern highlights that, at compilation time, anyObject does not need to know its type. Anyobject may be specified in the template files 202. Anyobject only acquires its identity at run time when the model files 204, comprising, for example, “PurchaseOrder”, are passed into the object creation code comprised within the MDA code generator 206. Model files 204 comprise information related to the specified field contained within the template files 202.

This coding pattern allows for a more generic code base to be designed at code generation time and thus simplify the MDA platform and the requirements of the MDA code generator 206. When this coding concept is applied throughout an application, it is then possible to customize the application by generative programming techniques and by altering the template files 202 or the model files 204. The generic MDA code generator 206 may be reused from application to application. The MDA code generator 206 may create the OMAP using the template files 202 and the model files 204.

One of the advantages of the present disclosure is the ability to simultaneously assign values to a plurality of fields of varying types using a single command. For instance, the input of an object for anyObject may appear as shown below:
anyObject.setField(“ID”,‘PO001’);

This approach enables a runtime object engine to intercept the action and perform runtime introspection on anyObject so that it can determine what other attributes are affected by this action and its relationship with other objects. The presently disclosed MDA code generator 206 can generate meta-model information at compilation time and utilize this information at runtime to achieve domain specific behavior for purpose such as production scheduling.

An example where this approach is particularly beneficial is in an MDA environment where a production order is rescheduled. The model files 204 comprise information that can be used by the template files 202 allowing for production tasks (children) to be re-scheduled automatically. In a conventional programming environment, a programmer has to program this behavior where necessary making it error-prone and expensive for customization.

Another advantage of the disclosed systems and methods is the use of the template files 202 to create a consistent UI that may be output as JSP 208. Not only does this allow for a consistent user interface, but any customization may also be reflected across the multiple tiers of the application and achieve what can be called design-time interoperability.

The schema of SQL 214 may be generated from the model files 204. The model files 204 language can provide an object to relational mapping that does not restrict a relational calculus from being performed by standard industry database servers.

The MDA code generator 206 creates the OMAP output. The OMAP may comprise any number of fields or parameters indicated by the template files 202. For instance, the OMAP may comprise production schedules, costs, suggested resource allocations, and other information used in production planning and scheduling. While the examples used in the disclosure are directed towards production scheduling and planning, it is expressly understood that these same examples may be applied to any field where collaborative real-time planning or model driven architectures may be implemented, as known to one skilled in the art.

The proposed MDA technology carries the above generic MDA paradigm further by generating the multiple tiers of code that form the entire application. Each tier will be generated by a tier-generator. A tier generator builds and maintains an entire tier within an application. In a web application server, this means the tier generator will handle one of the n-tiers of the application (e.g., database access, business logic or user interface).

With current software technologies and development process, when an interface changes, it is necessary to find each and every place where the interface is used, change it to use the new interface, test that new code, reintegrate, and then retest the system as a whole. A small change in the interface, therefore, may lead to many changes in the code.

The disclosed approach to generate multiple tiers of code provides the ability to address the above issue at design time. When an interface is changed, it is known at design time. Therefore, it is possible to re-generate source codes automatically at all the tiers based on the change. This is know as design-time interoperability. Given that such change can be handled consistently across all interface points in a matter of seconds, the efficiency and productivity of software engineering will be increased significantly.

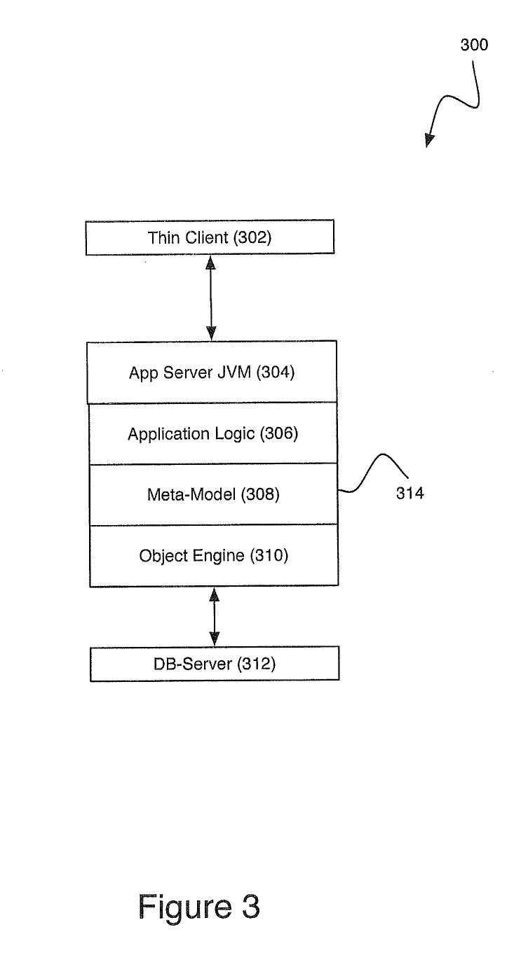

FIG. 3 is an example of a runtime system 300 used in client 112. In this example, a thin client 302 is in communication with a system 314 that comprises an application (“app”) server JVM 304, application logic 306, a meta model 308, and an object engine 310. A DB-server 312 is also shown in communication with the system 314. In this embodiment, the system 314 accesses data stored within the DB-server 312 and provides the data to the thin client 302. It is understood that this data flow is bidirectional. As in some embodiments, the thin client 302 may make changes to data within the meta model 308 stored in the system 314. These changes allow for real-time alteration of the OMAP based upon the current conditions of availability. It is understood that the system 300 including server 312 may be comprised within any client, including those disclosed in FIG. 1.

One of the innovative aspects of FIG. 3 is the ability for a thin client to make changes to data stored within the meta-model. For instance, in a production format, if a certain raw material becomes more expensive or unavailable, the data within the meta model may be updated with this information. In doing so, the meta-model may be used as gateway to update information within the system 300 and the system 200, as discussed below.

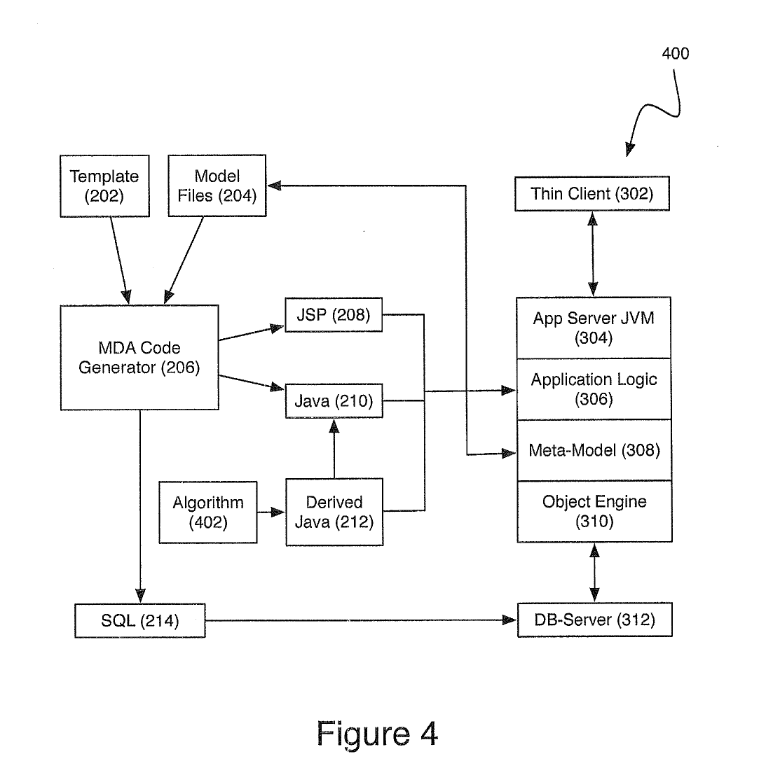

FIG. 4 is an integrated view of the systems 200 and 300. The arrows between 200 and 300 indicate a deployment activity whereby the generated JSP 208, Java 210, and SQL files 214 are deployed in the production environment. In this example, there is a relationship between the system 200 and the system 300, including a linking of the model files 204 to the meta-model 308, and a deployment of the JSP 208, JAVA 210, and derived Java 212 to the application logic 306. In addition, the SQL 214 may be used to provide schema or data to the DB-server 312. Loading of the model files 204 is accomplished by a run time object engine (RTOE). Using the runtime object engine, the model files 204 may be loaded during runtime to perform introspection on a domain object to determine its appropriate behavior and properties.

As illustrated by FIG. 4, the link between the runtime system 300 and the design system 200 provides an innovative feature wherein the system generates meta-model 308 information at compilation time and utilizes this information at runtime to achieve specific behavior. For example, in the Production and Scheduling domain, when a production is re-scheduled, all of its production tasks are re-scheduled automatically. In contrast, in a conventional programming environment, a programmer is often required to program this behavior where necessary, making the outcome more error-prone and expensive.

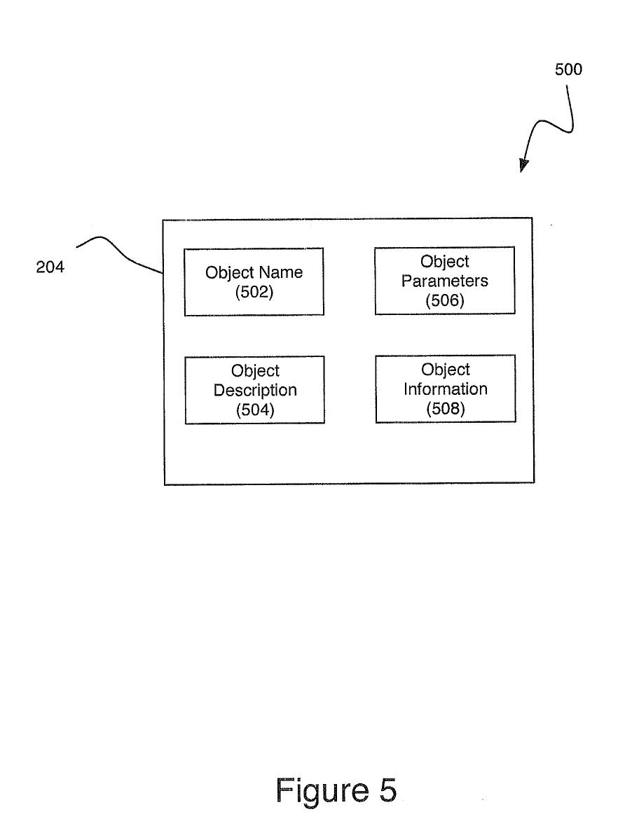

FIG. 5 is an example 500 of one embodiment of model files 204. In this example embodiment, an object name 502, an object description 504, an object parameters 506, and an object information 508 are shown. The object name 502 may comprise information that is related to a key name used in the object creation. Object description may be used to designate additional information about the object (e.g., location, color, part number or other characteristics, etc.). Object parameters, 506 may be used to designate information about the object, including information such as a relationship to other objects. Object information 508 may comprise information related to characteristics such as the availability of the object or how many are currently in stock.

Object model data may be loaded into the database as, for example:
Anyobject.instance(“Name”, “Description”, “Parameters”, “Information”)

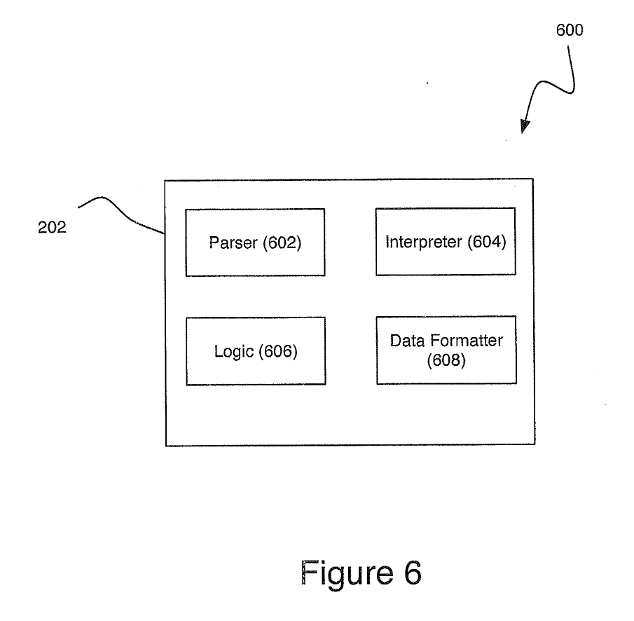

FIG. 6 shows an example 600 of a template file 202. In this example, template file 202 includes information related to a parser 602, an interpreter 604, a logic 606, and a data formatter 608. It is understood that the parser 602 relates to information embedded into the code that allows the template code to be parsed by the MDA code generator 206. The interpreter 604 may be used as a designation of the type of code interpreter to be used when parsing the logic 606 found within the template file 202. The logic 606 may be template code used to interpret the information within the object model data. The data formatter 608 may comprise instructions related to creating the UI or format results created within the MDA code generator 206.

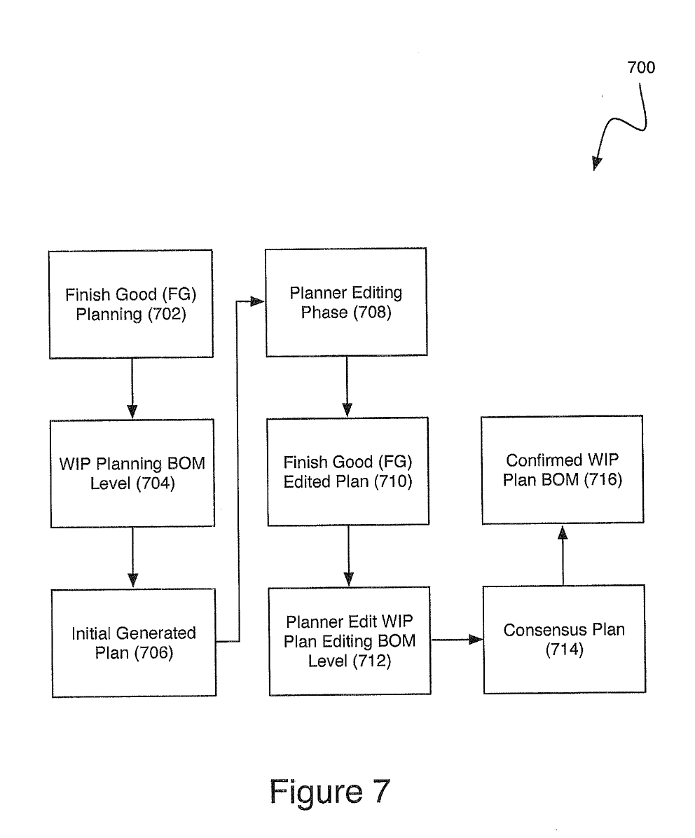

In order to use the system 100, a plurality of processes may be used. The steps of the disclosed process are described below in FIG. 7. A typical planning run for material and capacity planning is carried out using planning software that is persisted into DB-Server 312. The UI created through design system 200 allows the planners to perform the disclosed collaborative planning process through the following steps. First, planners responsible for different materials examine the plan in an order based on the level of the material, with the highest material being the finished goods. Next, the planners examine the sub-assemblies and then components created by the sub-assemblies.

The highest level planner will resolve conflicts such as late delivery by moving delivery tasks or production tasks or by starting a new production line, if need be.

It is understood that there may be changes that require editing of the planning. One of the innovative features of the present disclosure is that the ability to edit the information that is input into the MDA code generator 206 and thereby generate SQL 214, JSP 208 and Java 210 simultaneously allows for the ability to edit a plan in real time. The linking of the systems described in FIG. 2 and FIG. 3 as shown in FIG. 4 allows a plurality of clients to simultaneously interact and modify live data within the system 300. This simultaneous editing promotes real-time modification of the output including reports created by the system 100. Through the disclosed systems and methods, the ability to create, edit, and revise plans, reports, and code in real time is possible. For instance, if there is a change in the delivery date, the planner responsible for these materials attempts to enter this input into the system 300. and recreate the lowest level BOM examined and edited to the planner's satisfaction.

It is understood that once the previous planners have completed their entries, unresolved conflicts may remain. In such a case, adjustments may be made until the conflicts are resolved.

It is understood that these steps may be performed using the disclosed real time transactional planning platform via the Internet. This allows for a real time collaborative planning process between planners anywhere in the world.

FIG. 7 illustrates one method 700 of using the system 100 systems. In this example, a series of steps are taken that are used to create and revise an OMAP. In block 702, finish good (FG) planning is performed. This FG planning is done by a program generated by MDA Code Generator 206 based on template files 202 and information needed in the model files 204. For example, in a production environment, this block comprises determining what items are needed for producing a particular good and in what quantities. In block 704, work in progress (WIP) planning is performed. The WIP planning may include the inclusion of actual availability of items into the model files 204. In block 706, an initial generated plan is created using MDA code generator 206. It is understood that any number of iterations may be performed in block 704.

After an initial plan is created, the plan may be revised. This revision is made possible through the data access layer enabled by the elements found in FIGS. 2, 3, and 4. These revisions may be based upon business realities. In block 708, there is a planner-editing phase. This planning editing phase includes revising the plan created in block 702. In block 710, a finished good editing phase is conducted which is used to edit the information input during the WIP planning BOM level 704. In block 712 the planner edit WIP plan editing Bill of Materials (BOM) is completed.

Using the information created in block 712, a consensus plan is generated using in block 714. All reviewers review this consensus plan, and the consensus plan is confirmed in block 716.

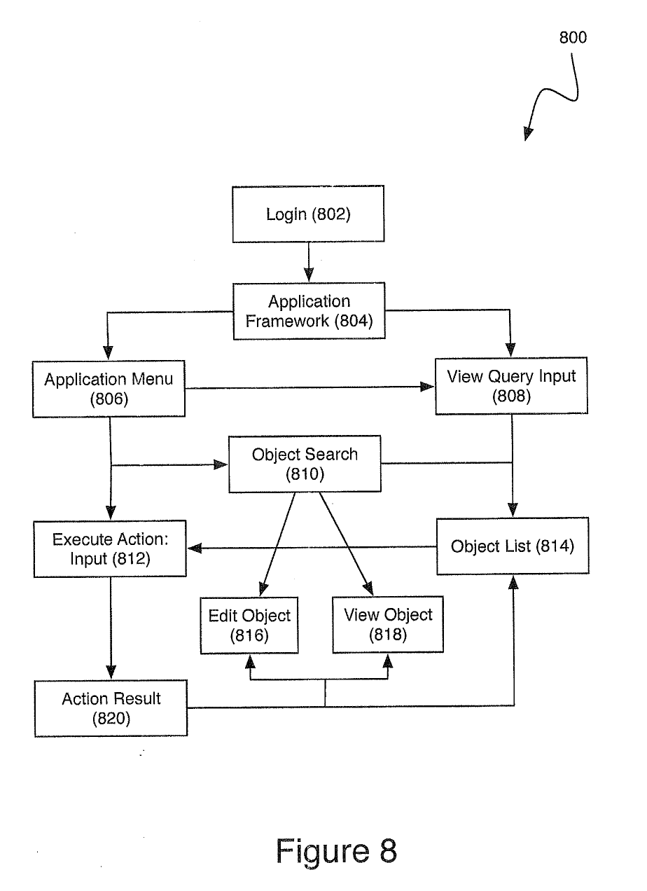

FIG. 8 is an example of a workflow that is generated by the template code 204. In this example, a user logs in at step 802. The user then accesses the application framework in step 804, and has an option to either access the application menu in step 806 or the view query input in step 808. Through the application menu step 806, the user may perform an object search in step 810 or execute an “execute action: input” in step 812. An example of the “execute action: input” in step 812 includes the modification of items contained within the model file in step 204. The object search in step 810 allows a user to edit an object in step 816, view an object in step 818, or obtains an object list in step 814. The view query object in step 808 allows also user to obtain an object list in step 814.

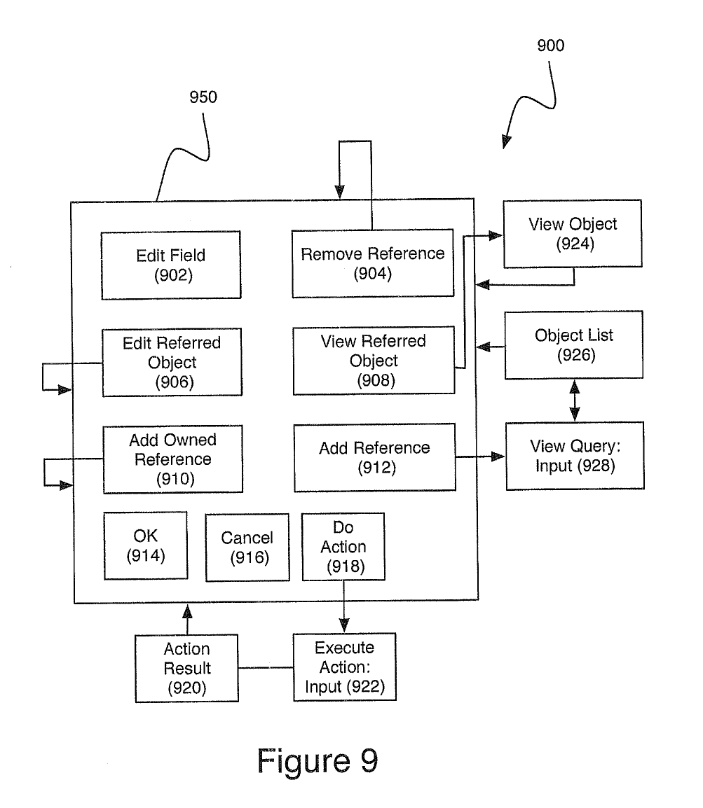

FIG. 9 is a block diagram of an interaction diagram, according to one embodiment of the present disclosure. In this diagram, an object 950 comprises an edit field method 902, a remove reference method 904, an edit referred object method 906, a view referred object method 908, an add owned reference method 910, and an add reference method 912. In addition, the object also contains an ok method 914, cancel method 916, and a do action method 918. The remove reference method 904, edit referred object method 906, and add owned reference method 910 commit to function, as described by the title of the object. The add reference method 912 may be used to commit a view query input method 928, and obtain an object list using the object list method 926. The view object method 925 may be accessed by the view referred object method 908. The do action method 918 allows for the “execute action: input” method 922 and the action result method 920.

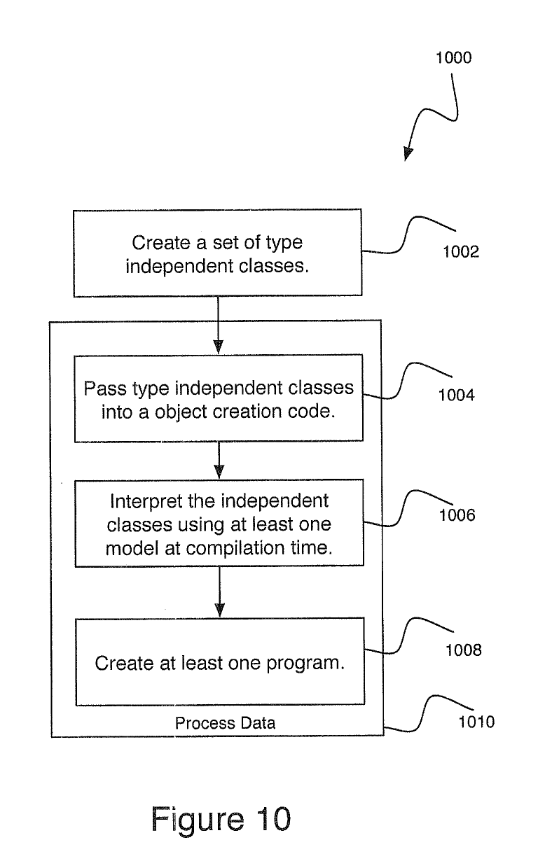

FIG. 10 is a flowchart 1000 of one method of processing data, performed by the present systems and methods. In this example, a set of type independent classes is created in block 1002. In block 1010, these classes are processed. The data processing includes passing type independent classes into an object creation code in block 1004. In block 1006, data from block 1004 is interpreted in the independent classes using at least one model at compilation time. In block 1008 at least one program is created from the interpretation data produced by block 1006.

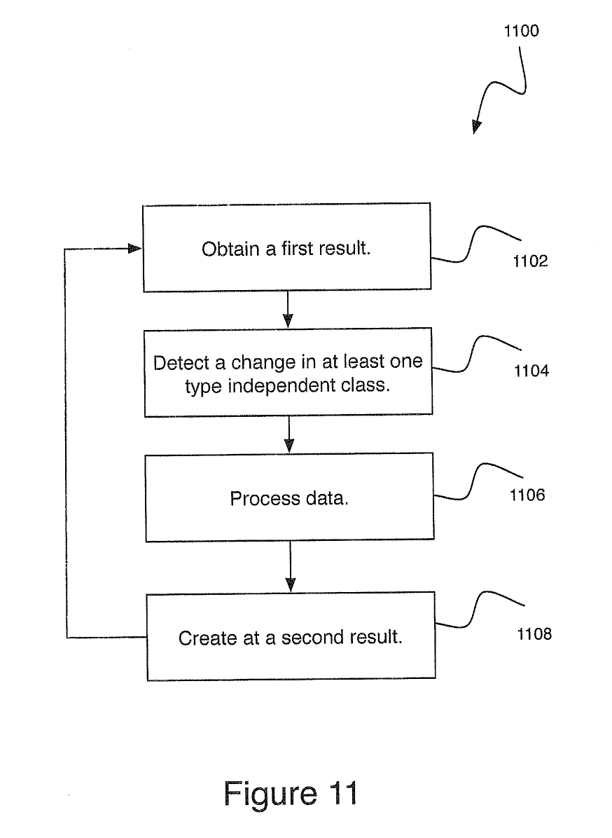

FIG. 11 is an example of one method of performing iterative analysis within runtime system 300 according to the present disclosure. In this example, a first OMAP result is generated in step 1102. There is a change to data detected in block 1104. The type independent class data is then processed using the changed data in block 1106. A second result is then created in block 1108. This process may be repeated a plurality of times, as described herein.

Type independent class data is described herein as data that is not designated with a particular type (e.g., integer, string, etc.). It is explicitly understood that any kind of data, including type independent class data, may be used with the systems and methods disclosed herein.

The disclosed systems and method have a plurality of advantages, including quality, consistency, productivity, and abstraction advantages. Hand code varies in quality through the lifecycle of a project. It may start high and end low, or vice versa. Generated code always increases in quality over time because as bugs or shortcomings are found they can be fixed in the code templates and applied across the code base.

Generated APIs are consistent in class structure, variable naming and signatures in the disclosed systems and methods. This is beneficial to the engineers or automated processes that sit on top of these APIs.

Generators, according to the disclosed systems and methods, build code in a fraction of the time that it takes an engineer to produce the equivalent amount of code. From another perspective, such generators allow an engineer to offload “grunt-work” so that he or she can concentrate on tasks that require more creative solutions.

Generators provide a layer of abstraction between the design and the code base. Business rules are often lost in the minute details of source code. The definition files used by these generators hold the schema and business rules for an application in a declarative form. In these definition files, edge cases stand out and can be documented. In addition the definition files can be inspected by domain experts.

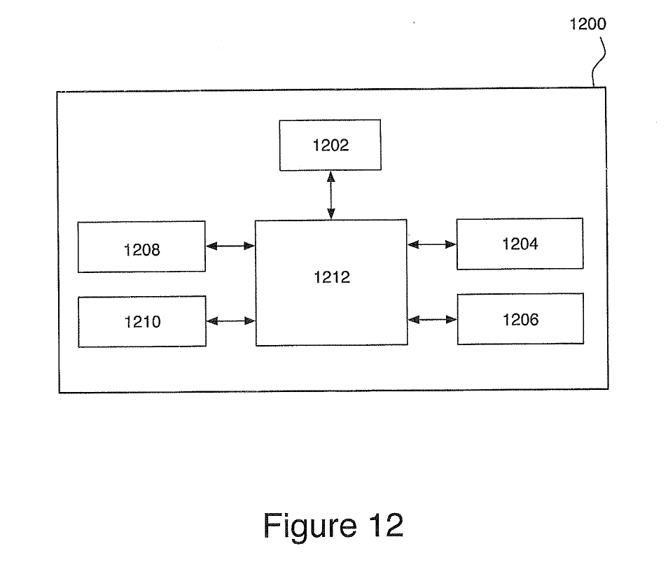

The clients 104, 110, and 112 described above may be implemented on any system 1200 with sufficient processing power, memory resources, and network throughput capability to handle the necessary workload placed upon it. FIG. 12 illustrates a system 1200 suitable for implementing one or more embodiments disclosed herein. The system 1200 includes a processor 1212 (which may be referred to as a central processor unit or CPU) that is in communication with memory devices including secondary storage 1202, read only memory (ROM) 1204, random access memory (RAM) 1206, input/output (I/O) devices 1208, and network connectivity devices 1210. The processor may be implemented as one or more CPU chips.

The secondary storage 1202 is typically comprised of one or more disk drives or tape drives and is used for non-volatile storage of data and as an over-flow data storage device if the RAM 1206 is not large enough to hold all working data. Secondary storage 1202 may be used to store programs that are loaded into RAM 1206 when such programs are selected for execution. The ROM 1204 may be used to store instructions and perhaps data that are read during program execution. ROM 1204 is a non-volatile memory device that typically has a small memory capacity relative to the larger memory capacity of secondary storage. The RAM 1206 is used to store volatile data and, in some embodiments, store instructions. Access to both ROM 1204 and RAM 1206 is typically faster than to secondary storage 1202.

I/O 1208 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 1202 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices.

These network connectivity devices 1210 may enable the processor 1212 to communicate with an Internet or one or more intranets. With such a network connection, it is contemplated that the processor 1212 might receive information from the network, or might output information to the network in the course of performing the above-described method steps. Such information, which is often represented as a sequence of instructions to be executed using processor 1212, may be received from and outputted to the network, for example, in the form of a computer data signal embodied in a carrier wave.

Such information, which may include data or instructions to be executed using processor 612 for example, may be received from and outputted to the network, for example, in the form of a computer data baseband signal or signal embodied in a carrier wave. The baseband signal or signal embodied in the carrier wave generated by the network connectivity devices 610 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 1212 executes instructions, codes, computer programs, scripts that it accesses from hard disk, floppy disk, optical disk (these various disk based systems may all be considered secondary storage 1202), ROM 1204, RAM 1206, or the network connectivity devices 1210.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

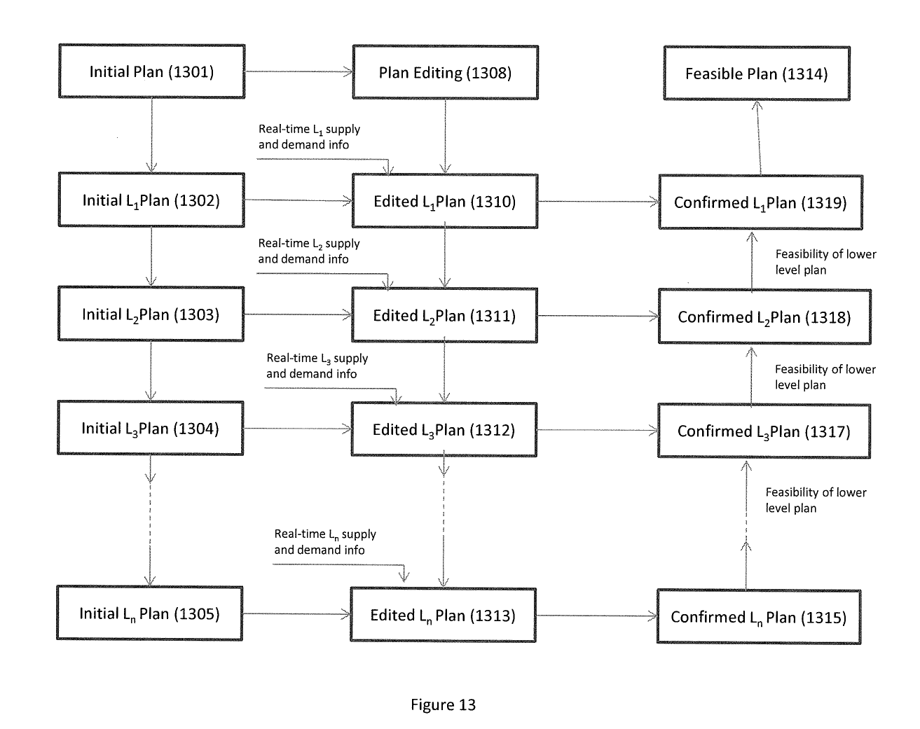

FIG. 13 illustrates an example material and capacity planning process for production of goods and services according to one embodiment of the present disclosure. A typical planning run for material and capacity planning is carried out using planning software that is persisted into DB-Server 312. This planning software is a program generated by MDA Code Generator 206 based on template fies 202 and information needed in the model files 204.

The material and capacity planning process can also be applied to other processes with differing flows of material and resources. The production process for goods may have multiple levels. For example, a production process for good may include ‘n’ levels, where level-n is the raw material, which gets processes into components, which in turn is processed into sub-assemblies, which is processed into finished goods at Level-1. All levels other than Level-1 L1 and Level-n may be referred to as Work-in-Progress (WIP). The number of levels of subassemblies and components can vary, and is indicated by level-2 L2, level-3 L3, and the like. FIG. 13 uses the notations L1 through Ln to indicate level-1 through level-n. In one embodiment, the CRP system may partition the plan at multiple levels. In another embodiment, the CRP system may partition the plan at multiple level according to an authority level each planner that uses the system. In this manner, planners may be constrained to edit only that part of the plan for which they have authority without impacting other parts of the plan.

The illustrated method of FIG. 13 shows a series of steps that may be taken to create, revise and confirm a production plan and output a report using the planning application. In block 1301, an initial generated plan is created using Planning application 314. As part of this initial plan, in block 1302, an initial Level-1 L1 plan is created in block 1302. For example, in a production environment, this block contains the finished good (FG) plan determining what finished goods are to be produced. In blocks 1302, 1303 and 1304 initial work-in-progress (WIP) plans are created. Initial raw material plan is created in block 1305.

After the initial plan is created, it may be edited in blocks 1308, 1310, 1311, 1312, and 1313. This editing is made possible through the data access layer as described above with reference to FIG. 3. These edits may be based upon any perceived changes to the plan, such as changes to business realities.

Once editing of the plan at each editing block 1308, 1310, 1311, 1312, and 1313 is completed, conflicts may remain unresolved. Thus, the plan may be confirmed at progressively higher levels in blocks 1317, 1318, and 1319 to resolve these conflicts. For example, the planner may compromise their plan at their BOM level to acknowledge the realities by relaxing their required time and quantity. Once the plan is confirmed in block 1319, it may be published in block 1314.

It is understood that there may be changes and other reasons that require editing of the initial plan. One feature may include editing the plan in a partitioned, collaborative manner in real time. The system 300 as generated by the system 200 allows multiple clients to simultaneously interact and modify live data within the system 300. This simultaneous editing may promote real-time modification of the output, such as reports created by the system 100.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

1-21. (canceled)

22. A method, comprising:
creating a template file, wherein the template file comprises at least one logic unit;
creating a model file, wherein the model file comprises at least one type independent information element, and wherein the type independent information element has at least two values associated with it;
interpreting the data comprised within the model file using the template file, wherein the interpretation is performed by at least one processor;
creating at least one program based upon the interpretation of the data;
revising the program based upon changes to the data by loading the same model file during runtime of the program using a run time object engine (RTOE) associated with the program; and
generating at least one report using at least one program.

23. The method of claim 22, further comprising using the generated report in a planning environment, the generated report comprising an optimized management allocation plan (OMAP) report.

24. The method of claim 22, wherein interpreting the data comprises interpreting the data using a model driven architecture code generator.

25. The method of claim 22, further comprising generating a user interface configured to receive the changes to the data.

26. The method of claim 25, further comprising communicating with a plurality of computers over a network, wherein the communication is used to make the changes to the data.

27. The method of claim 22, wherein revising the program comprises interpreting the data comprised within the model file based upon a change to the model file.

28. The method of claim 22, wherein the template file comprises logic and a description of a plurality of elements embedded in the model file.

29. A system comprising:
a memory configured to store a set of instructions, at least one template file, and at least one model file;
a processor configured to:
execute the set of instructions to interpret the at least one template file and import at least some data from the at least one model file;
generate a program comprising data related to the one template file and one model file; and
revise the program based upon changes to the data by loading the same model file during runtime of the program using a run time object engine (RTOE) associated with the program.

30. The method of claim 29, wherein the at least one report comprises an optimized management allocation plan (OMAP) report, and wherein the report is configured to be used in a planning environment.

31. The method of claim 29, wherein the processor is configured to interpret the at least one template file and import at least some data from the at least one model file using a model driven architecture code generator.

32. The method of claim 29, wherein the processor is configured to generate a user interface that receives the changes to the data.

33. The method of claim 32, wherein the processor is configured to communicate with a plurality of computers over a network, wherein the communication is used to make the changes to the data.

34. The method of claim 29, wherein the processor is configured to revise the program by interpreting the data comprised within the model file based upon a change to the model file.

35. The method of claim 29, wherein the template file comprises logic and a description of a plurality of elements embedded in the model file.

36. A system, comprising:
a memory configured to store at least one template file and at least one model file;
a processor configured to execute the instructions used to interpret the at least one template file and import at least some data from the at least one model file, wherein the processor generates a program comprising data related to the one template file and one model file,
wherein the program is partitioned into a plurality of editable levels.

37. The system of claim 36, wherein the plurality of editable levels have different editing constraints relative to one another, the editing constraint of each editable level corresponding to an authority level of each of a plurality of users.

38. The system of claim 36, wherein the processor is configured to re-generate the plurality of levels of the program in response to alteration of the at least one model file.

39. The system of claim 13, wherein the model stores type independent data.

40. The system of claim 13, wherein the report comprises information related to the production of at least one item.

41. The method of claim 40, wherein the at least one report comprises an optimized management allocation plan (OMAP) report, and wherein the report is configured to be used in a planning environment.
